(19) United States
(12) Patent Application Publication
(10) Pub. No.: US 2022/0391388 A1
(43) Pub. Date: Dec. 8, 2022

(54) AUTOMATIC REPLACEMENT OF COMMAND PARAMETERS DURING COMMAND HISTORY SEARCHING

(71) Applicant: Red Hat, Inc., Raleigh, NC (US)

(72) Inventors: Ilan Gersht, Bat Yam (IL); Arie Bregman, Gan Yavne (IL)

(21) Appl. No.: 17/341,653

(22) Filed: Jun. 8, 2021

(51) Int. Cl. G06F 16/2458; G06F 16/23

(52) U.S. Cl. CPC G06F 16/2474; G06F 16/2379

(57) ABSTRACT

A method includes receiving, by a processing device, a command search query for searching a command search history, identifying, by the processing device, a command from the command search history in view of the command search query, determining, by the processing device, that the command comprises a replaceable parameter, identifying, by the processing device, a content source corresponding to the replaceable parameter, and generating, by the processing device, an updated command by replacing the replaceable parameter with a data item from the content source.

### TECHNICAL FIELD

The present disclosure is generally related to computer systems, and more particularly, to automatic replacement of command parameters during command history searching.

### BACKGROUND

A shell (e.g., Linux shell) is a program or application that receives commands through a command line interface (CLI), translates the commands into system calls to access an operating system (OS) to perform a task, and returns an output. A terminal (e.g., Linux terminal) is a program that opens a window to implement a shell.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an example computer system architecture, in accordance with one or more aspects of the present disclosure.

FIG. 2 depicts a flow diagram of a method for automatically replacing command parameters during command history searching, in accordance with one or more aspects of the present disclosure.

FIG. 3 depicts a flow diagram of a method for determining that a command includes a set of replaceable parameters during the method of FIG. 2, in accordance with one or more aspects of the present disclosure.

FIG. 4 depicts a flow diagram of another method for determining that a command includes a set of replaceable parameters during the method of FIG. 2, in accordance with one or more aspects of the present disclosure.

FIG. 5 depicts a block diagram of an illustrative computer system operating in accordance with one or more aspects of the present disclosure.

### DETAILED DESCRIPTION

Described herein are methods and systems for automatically replacing command parameters during command history searching. Within a terminal, a history of shell commands that were previously executed (“command history”) can be searched. For example, search functionality can be invoked within the terminal by pressing a series of keys. One category of command search functionality that can be invoked is incremental searching. Incremental searching can be invoked to search a command history based on a query (e.g., user input). For example, if the search is an incremental search, the terminal can provide command suggestions from the command history based on the query. One example of an incremental search that can be performed is forward incremental searching (e.g., forward-i-searching). A forward incremental search can start at a current line and move down through the command history, as necessary. Illustratively, if a forward incremental search query includes a single letter “t”, the forward incremental search can provide a match for an oldest command in the command history, starting from the current line, that starts with “t”. Another example of an incremental search that can be performed is reverse incremental searching (e.g., reverse-i-searching). In contrast to a forward incremental search, a reverse incremental search can start at a current line and move up through the history, as necessary. Illustratively, if a reverse incremental search query includes a single letter “t”, the reverse incremental search can provide a match for a most recent command in the command history that starts with “t”.

It is often the case that commands can be repeated in a command history with minor changes. For example, assume that the following command is executed multiple times within the command history: <command> <flags> <parameter> <more flags>, where the only aspect changing from execution to execution is a parameter corresponding to “<parameter>”. Further assume that the parameter is inserted or pasted every time from some content source (e.g., from a copy buffer). In this case, the user would have to remove the previously used parameter found using the search functionality, and then insert the new parameter (e.g., from a copy buffer). This method is inefficient as the user has to manually change the parameter and the command can be very long, which can lead to replacing more information than what is needed and can take a long time. Moreover, the command could accidentally be run without first changing the parameter. Although aliases can be created for commands that can be paired with inputs corresponding to designated command parameters, an alias would have to be created by a user for each command. Therefore, each alias would have to be actively updated or managed to address any changes to the corresponding command.

Aspects of the present disclosure address the above noted and other deficiencies by automatically replacing command parameters during command history searching. For example, a terminal (e.g., Linux terminal) can receive (e.g., from a user) a command search query for searching a command search history, and identify a command from the command search history in satisfaction of the command search query. Upon determining that the command includes a set of replaceable parameters (i.e., one or more replaceable parameters), the systems and methods described herein can modify the command by replacing content of the replaceable parameter with source content from a corresponding content source (e.g., by inserting or pasting the source content). The content source can be, a copy buffer, a webpage, etc. The command can be modified while the terminal is operating in a replace or overtype mode. Various techniques can be used to determine whether the command includes a replaceable parameter.

A variety of methods can be used to determine whether the command includes a set of replaceable parameters. One method is based on an analysis of commands in the command search history having a same command structure as the command identified by the command search query. Here, it can first be determine in response to determining that a command structure of the command has repeated some number of times in the command search history. For example, while command search functionality (e.g., incremental searching) is invoked to search for a command, it is determined whether the number of times that the command has repeated within the command history satisfies a threshold condition (e.g., exceeds a threshold number of repeats). If so, it is then determined whether there is at least one parameter of the command that is changing between subsequent executions. If there is at least one parameter of the command that is changing between subsequent executions, then the at least one parameter of the command is identified as a replaceable parameter. Since the command can be determined to include multiple replaceable parameters in some instances, additional parsing may be needed to identify each replaceable parameter. Content of the at least one replaceable parameter can then be replaced with source content from a corresponding content source (e.g., copy buffer content from a copy buffer, webpage content from a webpage).

Another method is a deterministic method that employs unique sets of symbols placed in front of respective parameters. Each set of symbols corresponds to a content retrieval function for copying content from a particular content source, and inserting the content copied from the content source into its particular parameter. Each unique set of symbols can include one or more symbols that signify a content source (e.g., copy buffer, webpage). The set of symbols for each content retrieval function can be predefined (e.g., as a default definition and/or as a user-defined definition). During a command search for a command, the content retrieval function obtains source content from its corresponding content source. Accordingly, a command can include one or more content retrieval functions that can seamlessly replace the content of one or more respective parameters during a command search.

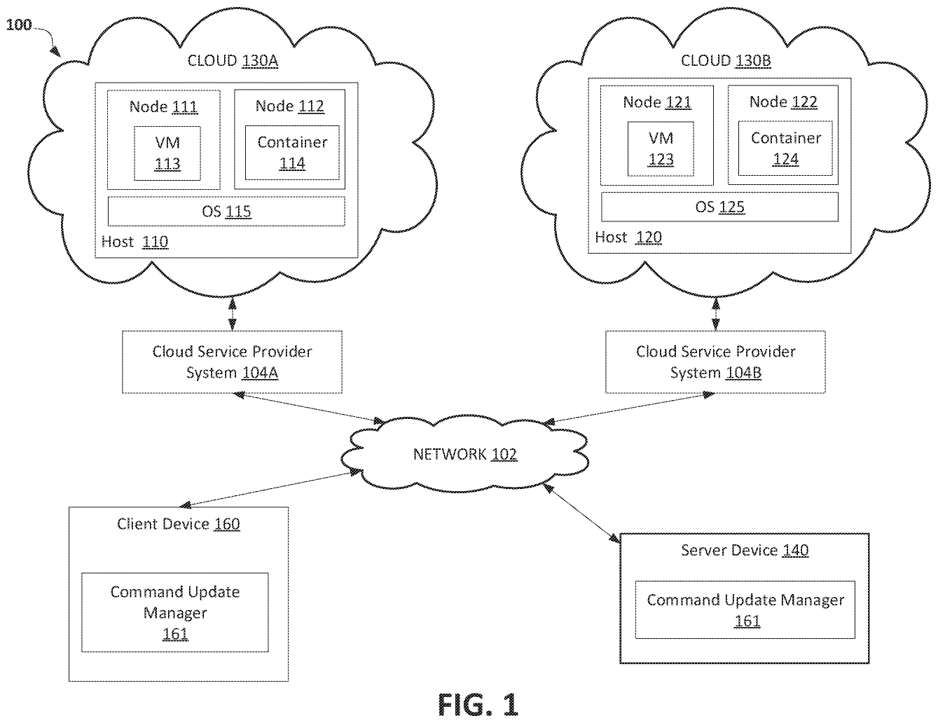

FIG. 1 is a block diagram of a network architecture 100 in which implementations of the disclosure may operate. In some implementations, the network architecture 100 may be used in a containerized computing services platform. A containerized computing services platform may include a Platform-as-a-Service (PaaS) system, such as Red Hat® OpenShift®. The PaaS system provides resources sources and services (e.g., micro-services) for the development and execution of applications owned or managed by multiple users. A PaaS system provides a platform and environment that allow users to build applications and services in a clustered compute environment (the “cloud”). Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

As shown in FIG. 1, the network architecture 100 includes one or more cloud-computing environment 130A, 130B (also referred to herein as a cloud(s)) that includes nodes 111, 112, 121, 122 to execute applications and/or processes associated with the applications. A “node” providing computing functionality may provide the execution environment for an application of the PaaS system. In some implementations, the “node” may include a virtual machine (VMs 113, 123) that is hosted on a physical machine, such as host 110, 120 implemented as part of the clouds 130A, 130B. For example, nodes 111 and 112 are hosted on physical machine of host 110 in cloud 130A provided by cloud provider 104A. Similarly, nodes 121 and 122 are hosted on physical machine of host 120 in cloud 130B provided by cloud provider 104B. In some implementations, nodes 111, 112, 121, and 122 may additionally or alternatively include a group of VMs, a container (e.g., container 114, 124), or a group of containers to execute functionality of the PaaS applications. When nodes 111, 112, 121, 122 are implemented as VMs, they may be executed by operating systems (OSs) 115, 125 on each host machine 110, 120. It should be noted, that while two cloud providers systems have been depicted in FIG. 1, in some implementations more or fewer cloud service provider systems 104 (and corresponding clouds 130) may be present.

In some implementations, the host machines 110, 120 can be located in data centers. Users can interact with applications executing on the cloud-based nodes 111, 112, 121, 122 using client computer systems (not pictured), via corresponding client software (not pictured). Client software may include an application such as a web browser. In other implementations, the applications may be hosted directly on hosts 110, 120 without the use of VMs (e.g., a “bare metal” implementation), and in such an implementation, the hosts themselves are referred to as “nodes”.

In various implementations, developers, owners, and/or system administrators of the applications may maintain applications executing in clouds 130A, 130B by providing software development services, system administration services, or other related types of configuration services for associated nodes in clouds 130A, 130B. This can be accomplished by accessing clouds 130A, 130B using an application programmer interface (API) within the applicable cloud service provider system 104A, 104B. In some implementations, a developer, owner, or system administrator may access the cloud service provider system 104A, 104B from a client device (e.g., client device 160) that includes dedicated software to interact with various cloud components. Additionally, or alternatively, the cloud service provider system 104A, 104B may be accessed using a web-based or cloud-based application that executes on a separate computing device (e.g., server device 140) that communicates with client device 160 via network 102.

Client device 160 is connected to hosts 110 in cloud 130A and host 120 in cloud 130B and the cloud service provider systems 104A, 104B via a network 102, which may be a private network (e.g., a local area network (LAN), a wide area network (WAN), intranet, or other similar private networks) or a public network (e.g., the Internet). Each client 160 may be a mobile device, a PDA, a laptop, a desktop computer, a tablet computing device, a server device, or any other computing device. Each host 110, 120 may be a server computer system, a desktop computer or any other computing device. The cloud service provider systems 104A, 104B may include one or more machines such as server computers, desktop computers, etc. Similarly, server device 140 may include one or more machines such as server computers, desktop computers, etc.

In some implementations, the client device 160 may include a command update manager 161. More specifically, the command update manager 161 can automatically update a command searched within a command history by automatically replacing command parameter content with content from corresponding content sources. For example, the command update manager 161 can determine that a command corresponding to a command search query has been repeated some number of times in satisfaction of a threshold condition, determine that one or more parameters of the command change in subsequent executions, and automatically replace the one or more parameters with content from one or more respective content sources to obtain an updated command. As another example, the command update manager 161 can determine that the command includes one or more symbols each invoking a call to a corresponding content source for inserting a parameter, identify each parameter as a replaceable parameter, and automatically replace the content of each parameter with content from the corresponding content source. In some implementations, the command update manager 161 can further run the updated command to perform a task.

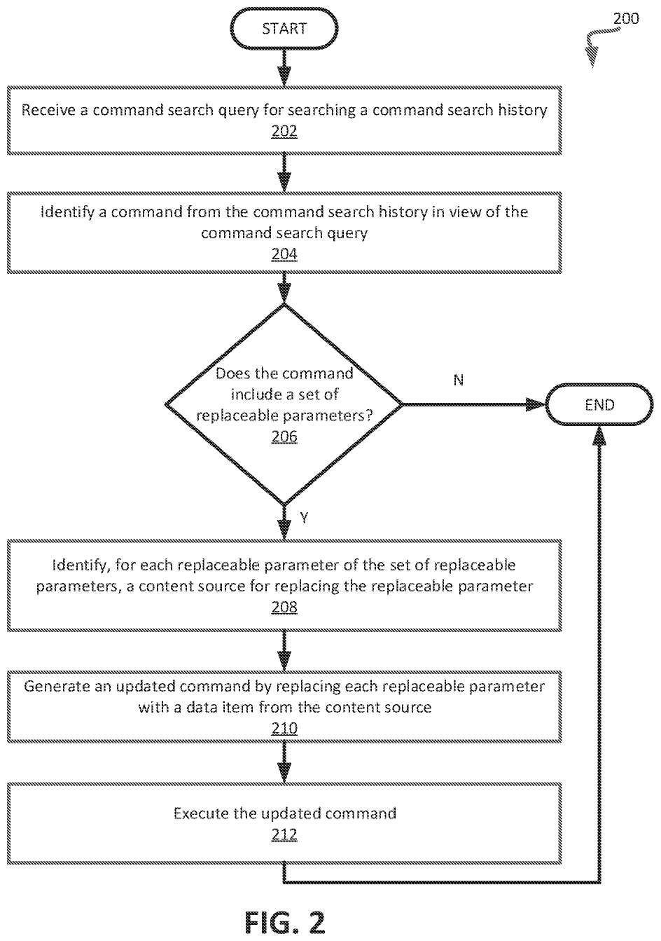

Command update manager 161 may be an application that executes entirely on client device 160. In other implementations, command update manager 161 may function in whole or in part on server device 140. In such instances, command update manager 161 can function as a web-based or cloud-based application that is accessible to the user via a web browser or thin-client user interface that executes on client device 160. In some implementations, a portion of command update manager 161 may execute on client device 160 and another portion of command update manager 161 may execute on server device 140. While aspects of the present disclosure describe command update manager 161 as implemented in a PaaS environment, it should be noted that in other implementations, command update manager 161 can also be implemented in an Infrastructure-as-a-Service (Iaas) environment associated with a containerized computing services platform, such as Red Hat® OpenStack®. The functionality of command update manager 161 to automatically replace a portion of a repeating command with content will now be described in further detail below with respect to FIGS. 2-4.

FIG. 2 depicts a flow diagram of an example method 200 for implementing replace modes for command searching, in accordance with one or more aspects of the present disclosure. The method may be performed by processing logic that may comprise hardware (circuitry, dedicated logic, etc.), computer readable instructions (run on a general purpose computer system or a dedicated machine), or a combination of both. In an illustrative example, method 200 may be performed by a command search manager, such as the command update manager 161 in FIG. 1. Alternatively, some or all of method 200 might be performed by another module or machine. It should be noted that blocks depicted in FIG. 2 could be performed simultaneously or in a different order than that depicted.

At block 202, the processing logic receives a command search query for searching a command search history. For example, the command search history can include a set of shell commands (e.g., a Linux shell command) received via a terminal (e.g., a Linux terminal). The command search query can be received after, or in combination with, invoking a particular type of search method. In some embodiments, the search method is an incremental search. For example, the search method can be a reverse incremental search. As another example, the search method can be a forward incremental search.

The command search query can include a set of characters. The command search query can generate a set of command search results in response to submitting a complete command search query. Additionally or alternatively, the command search history can be filtered in real-time to dynamically generate command search results after a character of the command search query is being entered into the terminal.

At block 204, the processing logic identifies a command from the command search history in view of the command search query. Identifying the command from the command history can include receiving a selection of a command from the command search history. For example, the command can be selected from the set of command search results generated in response to submitting a complete command search query, or can be selected from the dynamically generated command search results.

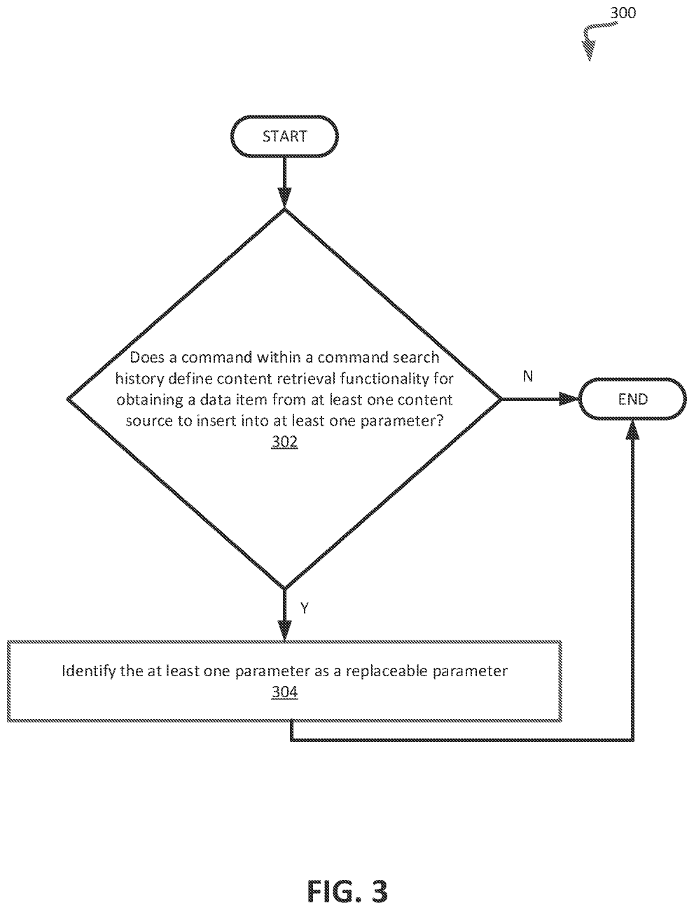

At block 206, the processing logic determines whether the command includes a set of replaceable parameters. Various methods can be used by the processing logic to determine whether the command includes a set of replaceable parameters. For example, the processing logic can determine whether the command includes a set of replaceable parameters based on the existence of content retrieval function(s) corresponding to respective parameter(s) in the command. More specifically, the processing logic can employ a content retrieval function to obtain source content from a particular content source, and insert the source content into its respective parameter. Since the content retrieval function per se defines a parameter as a replaceable parameter, this example is agnostic command repetition frequency in the command search history and/or changes in the parameter during subsequent execution. Further details regarding this example will be described below with reference to FIG. 3.

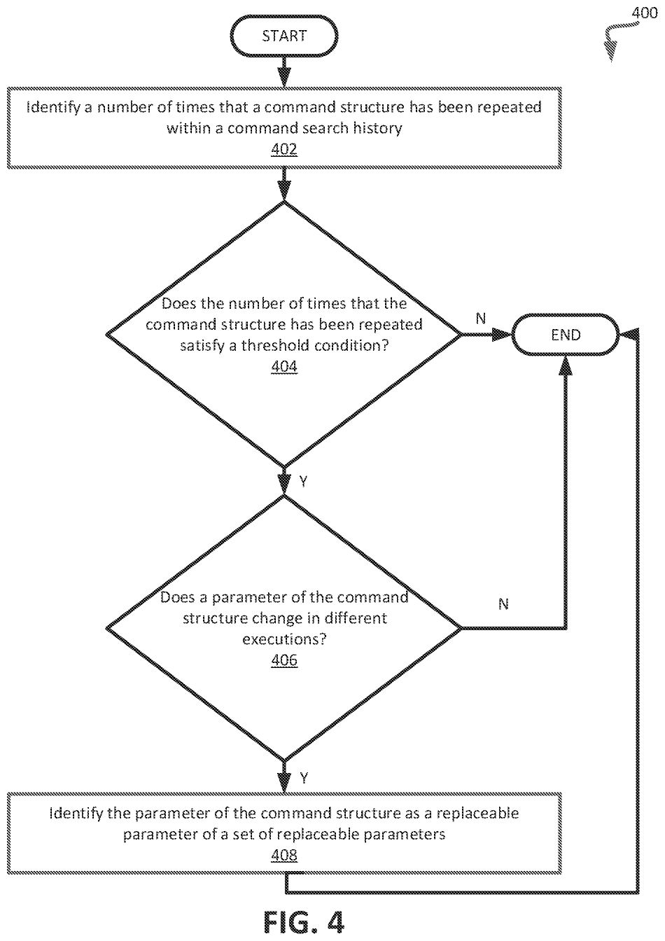

As another example, the processing logic can determine whether the command includes a set of replaceable parameters by determining whether the command includes any parameters that are observed as changing with respect to other command executions in the command search history. Further details regarding this example will be described below with reference to FIG. 4.

If the command is determined to not include a set of replaceable parameters, then content from the command is not to be replaced and the process ends. Otherwise, at block 208, the processing logic identifies, for each replaceable parameter of the set of replaceable parameters, a content source for replacing the replaceable parameter. For example, the content source can be a pre-defined content source from which to obtain a data item for insertion into the replaceable parameter. As another example, as will be described below with reference to FIG. 3, a set of symbols can identify both a replaceable parameter, and a content source from which to retrieve the data item for insertion into the replaceable parameter. In some embodiments, the content source(s) include a copy buffer (e.g., clipboard). In some embodiments, the content source(s) include a webpage.

At block 210, the processing logic generates an updated command by replacing each replaceable parameter with a data item from its corresponding content source. At block 212, the processing logic executes the updated command. The updated command can be executed automatically upon being generated, or can be executed upon receiving a request to execute the updated command.

In some cases, it may be impractical to replace each replaceable parameter with a data item from a content source. For example, if content is being obtained from a webpage, it may take a long time for such content to be read from the webpage, or access to the webpage may be disrupted (e.g., loss of Internet connection, webpage is down). To address this, a threshold amount of time can be set as part of the process of replacing each replaceable parameter with a data item from the content source at block 210. For example, if the amount of time it takes to obtain the content from the content source exceeds the threshold amount of time (e.g. 5 seconds), then a corrective action can be performed. For example, the action can include terminating the replacement process, at least for the corresponding parameter within the command. As another example, the action can include generating a message indicating that the process is still attempting to obtain the content from the content source. The action can be set as a default action and/or can be specified by a user.

FIG. 3 depicts a flow diagram of a method 300 for determining that a command includes a set of replaceable parameters during the method of FIG. 2, in accordance with one or more aspects of the present disclosure. The method may be performed by processing logic that may comprise hardware (circuitry, dedicated logic, etc.), computer readable instructions (run on a general purpose computer system or a dedicated machine), or a combination of both. In an illustrative example, method 300 may be performed by a command search manager, such as the command update manager 161 in FIG. 1. Alternatively, some or all of method 300 might be performed by another module or machine. It should be noted that blocks depicted in FIG. 3 could be performed simultaneously or in a different order than that depicted.

At block 302, the processing logic determines whether a command within a command search history defines content retrieval functionality for obtaining a data item from at least one content source to insert into at least one parameter. For example, a tool (e.g., software driver) can be programmed to identify the existence of at least one set of symbols corresponding to at least one parameter within the command. Each set of symbols designates a corresponding content source from which to obtain (e.g., copy) content for insertion into its corresponding parameter. Each set of symbols can include a single symbol, or can include multiple symbols. For example, a single symbol “$” can correspond to a first content source (e.g., a copy buffer), a group of symbols “#&@” can correspond to a second content source (e.g., webpage), etc. The set of symbols used for each content source can be set as a default setting and/or can be modified by a user.

If the command is determined to not include any content retrieval functionality, then the parameters within the command do not include any replaceable parameters, and the process ends. Otherwise, at block 304, the processing logic identifies the at least one parameter as a replaceable parameter of a set of replaceable parameters. There can be multiple replaceable parameters identified within a given command. Each of the replaceable parameters can have content replaced from a respective content source, and the content source can be identified by the particular symbol. Then, the replaceable parameter can be replaced with content from its corresponding content source. This can be performed for each replaceable parameter identified within the command to obtain an updated command, as described above with reference to FIG. 2. Accordingly, the content retrieval functionality can both determine the existence of a replaceable parameter, as well as identify the content source for replacing the replaceable parameter.

As an illustrative example, assume that the command history includes a command “mkdir $(pbpaste)” and a command “mkdir #(curl some_http_url)”, where “mkdir” is a command that creates a new directory, “curl” is a command-line tool for automatically transferring data to and/or from a server content source using a suitable protocol, and “pbpaste” refers to a copy buffer content source. The symbol “$” is provided as an illustrative example of a single symbol that signals that content for the corresponding parameter should be replaced from the content source “pbpaste” and the symbol “#” is provided as an illustrative example of a single symbol that signals that content for the corresponding parameter should be replaced from the content source “curl some_http_url”. By using a unique set of symbols for a content source, a data item can be dynamically copied from a content source (e.g., default or custom) and inserted into the parameter.

FIG. 4 depicts a flow diagram of another method for determining that a command includes a set of replaceable parameters during the method of FIG. 2, in accordance with one or more aspects of the present disclosure. The method may be performed by processing logic that may comprise hardware (circuitry, dedicated logic, etc.), computer readable instructions (run on a general purpose computer system or a dedicated machine), or a combination of both. In an illustrative example, method 400 may be performed by a command search manager, such as the command update manager 161 in FIG. 1. Alternatively, some or all of method 400 might be performed by another module or machine. It should be noted that blocks depicted in FIG. 4 could be performed simultaneously or in a different order than that depicted.

At block 402, the processing logic identifies a number of times that a command structure has been repeated with a command search history. The command structure refers to the general layout or framework of a command. For example, a command structure can be defined by a particular arrangement or order of functions and parameters in the command. Two commands are identical if they have the same command structure with the same inputs. However, commands having the same command structure may not be identical. For example, two commands can have the same command structure with at least one different parameter.

A search space for identifying the number of times that the command structure has been repeated can be adjusted or filtered based on one or more conditions. One example of a condition is a temporal condition. For example, the search space can be portion of the command search history from the past day, the past week, the past month, all time, etc. Another condition is a number of previous commands in the search history. For example, the search space can be the entire command search history, the last 10 commands, the last 50 commands, etc. Other examples of conditions are contemplated.

At block 404, it is determined whether the number of times that the command structure has been repeated satisfies a threshold criterion. The threshold criterion can be set as a default and/or can be user-defined. For example, the number of times that the command structure has been repeated can be compared to a threshold, and the number of times that the command structure has been repeated satisfies the threshold criterion if the number of times that the command structure has been repeated exceeds the threshold (e.g., greater than or equal to the threshold).

If the number of times that the command structure has been repeated does not satisfy the threshold criterion (e.g., does not exceed a threshold), then the command structure does not include any replaceable parameters, and the process ends. Otherwise, at block 406, the processing logic determines whether a parameter of the command structure changes in different executions of commands employing the command structure. In some embodiments, the different executions are subsequent executions (e.g., a first command and a second command executed after the first command as indicated by the command search history). In other embodiments, the different executions are separated by at least one other execution. A parameter can be identified in the command structure by a corresponding symbol (e.g., the double dash symbol can be used in front of content to indicate a parameter (--[parameter]).

For example, to perform the determination at block 406, the processing logic can select first command employing the command structure in the command search history, and compare the first command to a first set of other commands employing the command structure in the command search history to determine if the content of any of the parameters from the first command differs from the content of corresponding ones of the parameters of the other commands. If the comparison does not determine any parameters that change in subsequent executions, the process can select a second command employing the command structure in the command search history, and compare the second command to a second set of other commands employing the command structure in the command search history. For more efficient searching and comparison, the second set can include all of the commands from the first set except for the first and second commands (since the first and second commands were compared during the first comparison). The process can continue until (1) it is determined that there is at least one parameter having content that changes in different executions or (2) there are no more comparisons to be made (e.g., an n-th set of other commands is determined to be an empty or null set).

The search space for determining whether the content of any parameters of the command structure changes in different executions can be the same as the search space used to identify the number of times that the command structure has been repeated within the command search history. Alternatively, the search space for determining whether the content of the any of the parameters command structures changes in different executions can be different from the search space used to identify the number of times that the command structure has been repeated within the command search history. For example, in some embodiments, the search space used at block 402 can be filtered to generate a set of commands having the same command structure, and the determination at block 406 can be performed based on the set of commands.

If the content of all of the parameters of the command structure does not change in different executions (e.g., all of the commands have the same command structure include identical parameters in each execution over the search space), then the parameters within the command structure do not include any replaceable parameters, and the process ends.

Otherwise, at block 408, the processing logic identifies the parameter of the command as a replaceable parameter of a set of replaceable parameters. The set of replaceable parameters includes each parameter of the command structure that has been identified as a replaceable parameter.

Then, the replaceable parameter can be replaced with content from its corresponding content source. In some embodiments, the content source is a copy buffer. In some embodiments, the content source is a webpage. This content replacement can be performed for each replaceable parameter identified within the command to obtain an updated command, as described above with reference to FIG. 2.

As an illustrative example, assume that the following command has a command structure that is determined to have been repeated a number of times in a command history to satisfy a threshold condition: run--recursive--token--dest my.hostname. The parameters here are “recursive,” “token” and “dest.” Further assume that the parameter “token” has been identified as a replaceable parameter that changes between different command executions having the same command structure. The content corresponding to the parameter “token” can be copied from a dedicated webpage every time the command is run. Therefore, instead of searching for the command and then replacing the token content with the new token content, the embodiments described herein can automatically replace the token content with content from the dedicated webpage.

Multiple parameters can be replaced within a single command. As an illustrative example of this aspect, assume that a command history includes the following:
A-r1-f2-c3
A-r4-f5-c6
A-r 7-f8-c9
   If “10 11 12” is copied to a content source (e.g., copy buffer), then the following result can be generated during a search for the A command: A-r10-f11-c12. If multiple parameters were copied (e.g., separated by a space), the multiple parameters can be replaced accordingly in view of the command. Furthermore, multiple different content sources can be used within a single command. To illustrate this aspect, assume that a spreadsheet has the following columns and rows:
r|f|c
13 14 15

Then, based on the column names, values can replaced to get the following output in the terminal: A-r 13-f14-c15.

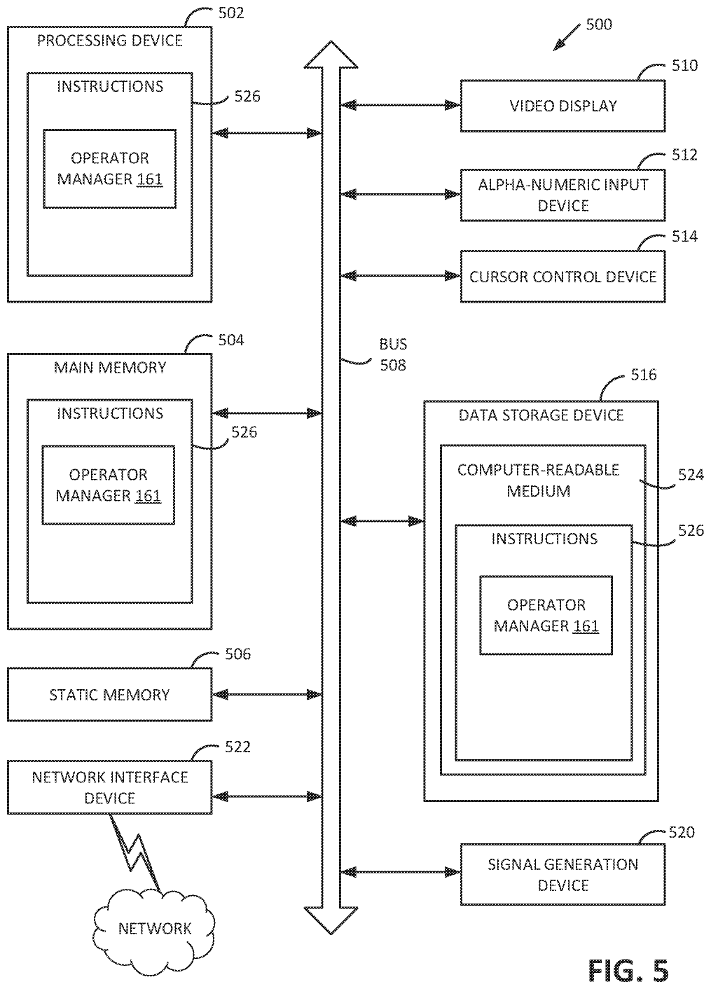

FIG. 5 depicts an example computer system 500 which can perform any one or more of the methods described herein. In one example, computer system 500 may correspond to computer system 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while a single computer system is illustrated, the term “computer” shall also be taken to include any collection of computers that individually or jointly execute a set (or multiple sets) of instructions to perform any one or more of the methods discussed herein.

The exemplary computer system 500 includes a processing device 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 516, which communicate with each other via a bus 508.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute processing logic (e.g., instructions 526) that includes command update manager 161 for performing the operations and steps discussed herein (e.g., corresponding to the method of FIGS. 2-4, etc.).

The computer system 500 may further include a network interface device 522. The computer system 900 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker). In one illustrative example, the video display unit 510, the alphanumeric input device 512, and the cursor control device 514 may be combined into a single component or device (e.g., an LCD touch screen).

The data storage device 516 may include a non-transitory computer-readable medium 524 on which may store instructions 526 that include command update manager 161 (e.g., corresponding to the methods of FIGS. 2-4, etc.) embodying any one or more of the methodologies or functions described herein, command update manager 161 may also reside, completely or at least partially, within the main memory 504 and/or within the processing device 502 during execution thereof by the computer system 500, the main memory 504 and the processing device 502 also constituting computer-readable media. Command update manager 161 may further be transmitted or received over a network via the network interface device 522.

While the computer-readable storage medium 524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Other computer system designs and configurations may also be suitable to implement the systems and methods described herein.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “receiving,” “determining,” “providing,” “selecting,” “provisioning,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not have an ordinal meaning according to their numerical designation.

What is claimed is:

1. A method comprising:
receiving, by a processing device, a command search query for searching a command search history;
identifying, by the processing device, a command from the command search history in view of the command search query;
determining, by the processing device, that the command comprises a replaceable parameter;
identifying, by the processing device, a content source corresponding to the replaceable parameter; and
generating, by the processing device, an updated command by replacing the replaceable parameter with a data item from the content source.

2. The method of claim 1, wherein determining that the command comprises a replaceable parameter comprises:
identifying a number of times that a command structure of the command has been repeated within the command search history;
determining that the number of times that the command structure has been repeated satisfies a threshold condition;
in response to determining that the number of times that the command has been repeated satisfies the threshold condition, determining that a parameter of the command structure changes in different executions of commands employing the command structure; and
identifying the parameter as the replaceable parameter.

3. The method of claim 1, wherein determining that the command comprises a replaceable parameter and identifying the content source comprises:
determining that the command defines content retrieval functionality for obtaining the data item from the content source to insert into a parameter of the command; and
identifying the parameter as the replaceable parameter.

4. The method of claim 3, wherein the content retrieval functionality comprises a set of symbols identifying the replaceable parameter and the content source.

5. The method of claim 1, wherein the content source comprises a copy buffer.

6. The method of claim 1, wherein the content source comprises a webpage.

7. The method of claim 1, further comprising executing, by the processing device, the updated command.

8. A computing system comprising:
a memory; and
a processing device, operatively coupled to the memory, to:
receive a command search query for searching a command search history;
identify a command from the command search history in view of the command search query;
determine that the command comprises a replaceable parameter;
identify a content source corresponding to the replaceable parameter; and
generate an updated command by replacing the replaceable parameter with a data item from the content source.

9. The computing system of claim 8, wherein, to determine that the command comprises a set of replaceable parameters, the processing device is to:
identify a number of times that a command structure of the command has been repeated within the command search history;
determine that the number of times that the command structure has been repeated satisfies a threshold condition;
in response to determining that the number of times that the command has been repeated within the command history exceeds a threshold, determine that a parameter of the command structure changes in different executions of commands employing the command structure; and
identify the parameter as the replaceable parameter.

10. The computing system of claim 8, wherein, to determine that the command comprises a replaceable parameter, the processing device is to:
determine that the command defines content retrieval functionality for obtaining the data item from the content source to insert into a parameter of the command; and
identify the parameter as the replaceable parameter.

11. The computing system of claim 10, wherein the content retrieval functionality comprises a set of symbols identifying the replaceable parameter and the content source.

12. The computing system of claim 8, wherein the content source comprises a copy buffer.

13. The computing system of claim 8, wherein the content source comprises a webpage.

14. The computing system of claim 8, wherein the processing device is further to execute the updated command.

15. A non-transitory machine-readable storage medium storing instructions which, when executed, cause a processor to perform operations comprising:
receiving a command;
determining that the command defines content retrieval functionality for obtaining a data item from a content source to insert into a parameter of the command; and
generating an updated command by replacing the parameter with the data item from the content source.

16. The non-transitory machine-readable storage medium of claim 15, wherein the operation further comprise receiving a command search query for searching a command history, and wherein receiving the command comprises identifying the command from the command search history in view of the command search query.

17. The non-transitory machine-readable storage medium of claim 15, wherein the content retrieval functionality comprises a set of symbols identifying the replaceable parameter and the content source.

18. The non-transitory machine-readable storage medium of claim 15, wherein the operations further comprise:
determining that the command comprises a second replaceable parameter; and
identifying a second content source corresponding to the replaceable parameter;
wherein obtaining the updated command further comprises replacing the second replaceable parameter with content from the second content source.

19. The non-transitory machine-readable storage medium of claim 15, wherein the content source comprises at least one of: a copy buffer or a webpage.

20. The non-transitory machine-readable storage medium of claim 15, wherein the operations further comprise executing the updated command.
